(19) United States
(12) Patent Application Publication
(10) Pub. No.: US 2014/0034750 A1
(43) Pub. Date: Feb. 6, 2014

(54) AUTONOMOUSLY DISPLACEABLE FEED DISPLACEMENT VEHICLE

(71) Applicant: Lely Patent N.V., Maassluis (NL)

(72) Inventors: Jan Martinus VAN KUILENBURG, WADENOYEN (NL); Iwan Yves VLAAR, ZEGGE (NL); Karel VAN DEN BERG, BLESKENSGRAAF (NL)

(73) Assignee: Lely Patent N.V., Maassluis (NL)

(21) Appl. No.: 14/051,480

(22) Filed: Oct. 11, 2013

Related U.S. Application Data
(63) Continuation of application No. PCT/NL2012/000024, filed on Mar. 28, 2012.

(30) Foreign Application Priority Data
Apr. 11, 2011 (NL) 1038740

(51) Int. Cl. A01K 5/00

(52) U.S. Cl. CPC A01K 5/00
USPC 239/71; 239/172

(57) ABSTRACT

A feed displacement vehicle which can move on a surface autonomously, the vehicle comprising a frame which is provided with a drive mechanism, a feed displacement device configured to push aside feed situated on the surface, a container for a feed supplement to be dispensed, and a dispensing device for dispensing the feed supplement from the container. The vehicle further comprises an adjustment device configured such that the dispensing device of the vehicle can be adjusted in order to dispense the feed supplement at a desired, adjustable dispensing distance.

### CROSS REFERENCE TO RELATED APPLICATIONS

This application is a continuation of PCT application number PCT/NL2012/000024 filed on 28 Mar. 2012, which claims priority from Netherlands application number 1038740 filed on 11 Apr. 2011. Both applications are hereby incorporated by reference in their entireties.

### BACKGROUND OF THE INVENTION

1. Field of the Invention

The present invention relates to a feed displacement vehicle which can move on a surface autonomously, comprising a frame which is provided with a drive mechanism, a feed displacement device which is configured to push aside feed situated on the ground, a container for a feed supplement to be dispensed, and a dispensing device for dispensing the feed supplement from the container.

2. Description of the Related Art

FR-2862489 discloses an autonomous vehicle for lateral displacement of feed for goats which has a deflector on the bottom side of the vehicle. Above and on the side of this deflector, a chute extends for dispensing concentrate from a container on the vehicle to the feed situated on the ground. The chute may be collapsible.

Moreover, in the December 2008 issue of the magazine Geitenhouderij [Goat Keeping], page 29, a prototype is described of a device according to the preamble, based on the Lely Juno™ (Lely Patent N. V., Maassluis, The Netherlands) and provided with a feed trough. This prototype is said to be usable for feed, although no further details are given.

It is a drawback of these known devices that they are not able to dispense the concentrate efficiently under all circumstances.

### BRIEF SUMMARY OF THE INVENTION

The aforementioned disadvantages are overcome by providing an autonomous feed displacement vehicle which dispenses feed supplement in a reliable and efficient manner, the vehicle comprising an adjustment device configured such that a dispensing device of the vehicle can be adjusted in order to dispense the feed supplement at a desired, adjustable dispensing distance.

The invention is based on the insight that in some cases there is more feed on the ground than can be pushed by a feed displacement vehicle towards and within reach of the animals. Thus, in the known device, the chute, which is indeed collapsible but not adjustable, is in many cases too far removed from the animals, at least from the intended spot for dispensing feed. This occurs in particular if roughage is dispensed for a number of days, resulting in the resistance of the mound of feed becoming too great for it to be pushed aside. By making the dispensing device, and thus the dispensing distance, adjustable, it becomes possible to dispense the feed supplement in a suitable, desired spot in this situation as well. It should be noted that, according to the present invention, it is possible to dispense relatively large amounts of roughage simultaneously, because the feed supplements, such as additives, can be dispensed to the animals in a convenient way. When the animals have “eaten away” a sufficiently large amount, the vehicle can push the feed further and still dispense the feed supplement at a correct distance.

A feed pusher by the trade name Lely Juno™ is also known which comprises a self-propelled frame with a surrounding feed-pushing skirt, but having no feed supplement container or feed supplement-dispensing device. For further details, the reader is referred to, inter alia, WO2007120036A1 and WO2009070007A1, which are incorporated herein by reference in their entireties.

The adjustment device or means may, for example, be adjusted manually before the pushing of feed in a feed alley. Depending on the amount of feed to be pushed, the dispensing distance can be modified. Thus, a different dispensing distance can be used if feed is dispensed more often, but in amounts which are smaller each time, than when feed is dispensed less often, but in greater amounts. In this way, it is also possible to adjust the vehicle to different animals, e.g., to set a short distance for (pygmy) goats, and a larger distance for cows. It is also possible to use different settings for different development or growth stages of one animal species, such as calf, yearling and heifer in the case of dairy cattle. Advantageously, the adjustment means is designed in order to, autonomously and on the basis of at least one position-dependent parameter, adjust the dispensing distance of the dispensing device. This not only has a labour-saving effect resulting from the fact that the vehicle can autonomously adjust the dispensing distance, but it also enables the vehicle to react dynamically to changing local circumstances. For example, the amount of feed to be pushed may vary to a greater or lesser degree locally. As a result, the desired dispensing distance may also vary to a greater or lesser extent. Due to the fact that the vehicle can automatically take this variation into account, feed supplement can be dispensed in an optimum manner and with as little loss as possible and, for example, in an optimum range for different animals.

In the present application, the expression “able to move on the ground autonomously” means that the vehicle is self-propelled and can find its way on the ground on its own, for example, in an animal shed. In this case, the vehicle is designed to move freely in two directions. Devices which move, for example, along a rail or another fixed guide, optionally (also) resting on the ground, are thus excluded. The term “feed supplement” is intended to mean an additive or a mixture of additives for feed in general and in particular for roughage. Possible examples are various types of (concentrate) pieces, minerals, but also, for example, additives to make the roughage more attractive to the animals, such as molasses. It is also possible to include specific kinds of (general) medicines or health-improving additives.

The term “dispensing distance” is intended to mean the dispensing distance with respect to the vehicle or with respect to an external point of reference, such as a guide means, as will be explained in more detail below. Alternatively and in general, it is possible to refer to a dispensing position which can be determined with respect to a position or an instant position of the vehicle, or with respect to an external point of reference, such as a feeding fence. It is emphasized here that the adjustability of the dispensing distance requires that it can assume at least two different values at which feed supplement is actually dispensed. This only excludes the possibility of optionally dispensing feed supplement.

The term “local” parameter is understood to mean a parameter which is determined in situ and which may therefore differ from location to location.

In an embodiment of the invention, a parameter is the distance of the vehicle to a guide means or guiding device, in particular to a feeding fence. The vehicle then comprises a distance-determining means which is designed to determine the distance between the vehicle and the guide means. A self-propelled vehicle will often use such a guide means in order to determine the route to be travelled, since this is indeed often functionally determined by, for example, a feeding fence. In general, the vehicle will try to keep a fixed distance to the guide means. In such a case, the dispensing distance for the feed supplement will also be constant. However, if there is too much feed on the ground or if an obstacle is present and the vehicle cannot keep the distance as a result thereof, it is still possible to set the dispensing distance in a favourable manner. It should be noted that said dispensing distance is here advantageously measured with respect to the guide means and not with respect to the vehicle.

The distance-determining device may, for example, be an ultrasound sensor or an (optical) 3D camera, for example based on a delay sensor or a phase-shift sensor or also, for example, a GPS device. In this case, use may alternatively or additionally be made of local beacons or of guide systems which are optionally provided in the ground, such as guides or optical identification marks.

Advantageously, the adjustment means is designed to adjust the dispensing distance within a predetermined access range with respect to the guide means. This makes it possible to set a desired dispensing distance, for example depending on the animal, which is, for example, closer to the feeding fence for small animals than for large animals. If desired, the dispensing distance is dependent on animal identification. As a result, the vehicle itself can set the dispensing distance (e.g. with respect to the guide means) on the basis of animal identification. In a particularly advantageous embodiment, the dispensing distance can also be linked to the determined width of a material on the ground or surface. In particular, the access range may be chosen as a central section of the material on the ground, also referred to as its “back”. An advantage of dispensing the feed supplement on this part is that it will almost always be sufficiently flat to prevent the feed supplement from sliding off the material. If chunks of feed supplement were to roll down the slanting side of a mound of feed, this would result in waste. The expression “central section” as used here is effectively meant to refer to a section which is sufficiently flat to prevent the feed supplement from rolling down. Obviously, this section may be determined in practice. However, at least 0.3 m from the vehicle is a good guideline, that is to say effectively that part of the material on the ground which is situated at least 0.3 m from the vehicle. In this case, it is assumed that feed supplement which rolls down the material on the side facing the animal can indeed be reached by the animals.

In a further embodiment of the invention, the vehicle comprises a material-detecting device which is designed for detecting material on the ground, in particular feed. In this case, a parameter is the presence of detected material on the ground, preferably the area in which said material on the ground is detected. Such a material-detecting device may, for example, comprise a camera with image-processing software. The camera may, for example, be an ultrasound camera or an optical camera, such as a video camera or a 3D camera. On the basis of the detected image, it is possible, for example, by comparing a detected colour with a reference colour of the feed, to determine whether there is actually feed on the ground or whether it is something else. An alternative way of detecting material on the ground is described in the abovementioned document WO2009070007A1, where a torque difference-determining device detects a difference in torque on the driven wheels. If no difference is detected or if a detected difference corresponds to a minimum possible difference, the control circuit infers that there is no material or feed present, whereas with a greater difference in torque the control circuit infers that material or feed is present.

Advantageously, the material-detecting device is designed for detecting material on the ground viewed in a direction perpendicular to a direction of movement of the vehicle, and more particularly between the vehicle and the guide means. Thus, the dispensing device can always be set as a function of the local circumstances. To this end, it is advantageous if the material-detecting device, such as a camera, has a sufficiently narrow image field and/or that the control circuit or image processing software uses a sufficiently small part of the image to set the dispensing device Consideration may be given to an image field width which is, for example, half the size of the length of the vehicle, viewed in the direction of movement of the vehicle.

In a further embodiment, the adjustment means is designed for adjusting the dispensing distance within the range in which the material on the ground has been detected. This provides additional flexibility when dispensing the feed supplement, since it becomes possible to be more flexible with regard to pushing aside material or feed situated on the ground, as no fixed distance has to be kept with respect to, for example, a feeding fence. In this embodiment, the material on the ground can also be pushed together until it exerts a certain resistance on the vehicle or until it reaches a certain height, etc. The dispensing distance will also vary. With the known device, on the other hand, the fixed distance could result in problems, such as collisions with the feeding fence, etc. In particular, the adjustment means is designed to dispense on material which has been detected on the ground, more particularly only on material which is situated on the ground. The situation may occur that there is no feed along a section of the path. In that case, it is disadvantageous to dispense feed supplement, because, for example, it is difficult for the animals to eat flour or minerals off the ground or because the feed supplement comprises a liquid feed supplement, such as molasses. By designing the vehicle in such a manner that the feed supplement is preferably only dispensed on material which has been detected on the ground, such waste of feed supplement is efficiently prevented.

In particular, the dispensing device comprises a chute, auger, conveyor belt or any combination thereof. Such dispensing devices are simple, easy to operate and very reliable. However, alternative dispensing devices are not excluded, such as a spraying device for liquid feed supplements such as molasses.

In a further embodiment, the adjustment means comprises an angle and/or length adjustment means of the chute, auger, conveyor belt or combination thereof. Such an adjustment means can , for example, further comprise an electric/stepping motor which is controlled by the auger, conveyor belt, chute or combination thereof. By being able to adjust the length and/or angle position of the dispensing means, it is possible to adjust the dispensing distance in a simple and reliable way. In this case, calibration measurements may be carried out beforehand in order to be able to take into account not only the geometrical consequences of angles and dimensions, but also the falling behaviour of different types of feed supplement. Advantageously, the adjustment means is operatively coupled to a distance-determining device, in particular that which determines a distance of the vehicle from a guide means, such as the feeding fence. Thus, it is possible to ensure in an even more reliable manner that the feed supplement falls on detected material or feed which is situated on the ground.

Alternatively or additionally, the adjustment means comprises a dispensing rate adjustment device or means. This may, for example, comprise an auger or belt speed adjustment means, or, for alternative dispensing means, spraying pressure adjustment means for feed supplements such as liquid feed supplements, etc. It is also possible to adjust the dispensing distance within certain boundaries by varying the dispensing speed of the feed supplement. Calibration measurements may be carried out beforehand. The adjusting device may then in each case refer to, e.g., a table containing these calibration measurements in order to set a desired dispensing distance.

In a further embodiment, the dispensing device is designed to vary the dispensing distance, in particular according to a pattern, more particularly according to a regular pattern. As a result thereof, the device can spread the feed supplement over the feed situated on the ground, thus, for example, making it possible to render a larger proportion thereof more attractive to the animals. In this way, it is also possible to improve the intake of the feed supplement by the animals. To this end, the dispensing device may comprise an adjustment means which is designed to perform an oscillating movement. The oscillating movement is preferably regular, such as a sinus or triangular movement, but may, alternatively, for example, also be an arbitrary movement. After all, there is always a range within which animals can reach and eat the feed and thus also the feed supplement which has been dispensed thereon. It should be noted that during a subsequent tour past the feed, a new dose of feed supplement will, in almost all cases, be dispensed in a different spot, so that ultimately every part of the feed has received a dose of feed supplement. Alternatively, the dispensing device may be designed to dispense the feed supplement over a substantial part, at least half, of the range within which the animals can access the feed. To this end, the device may, for example, comprise an adjustable spreading plate or nozzle.

### BRIEF DESCRIPTION OF THE DRAWINGS

The features and advantages of the invention will be appreciated upon reference to the following drawings, in which:

FIG. 1 shows a diagrammatic side view in cross section of an embodiment according to the invention;

FIG. 2 shows a diagrammatic top view of an embodiment according to the invention; and

FIGS. 3a-c diagrammatically show several dispensing scenarios.

### DESCRIPTION OF ILLUSTRATIVE EMBODIMENTS

The following is a description of certain embodiments of the invention, given by way of example only and with reference to the drawings.

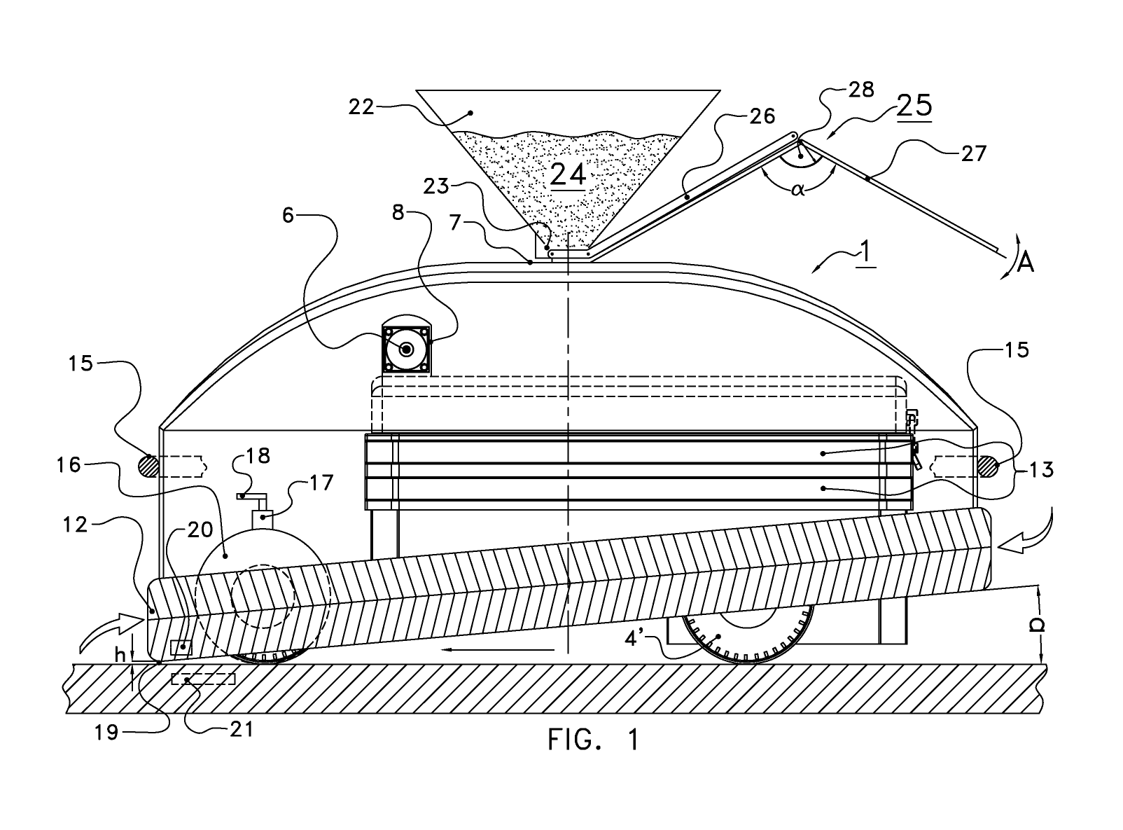

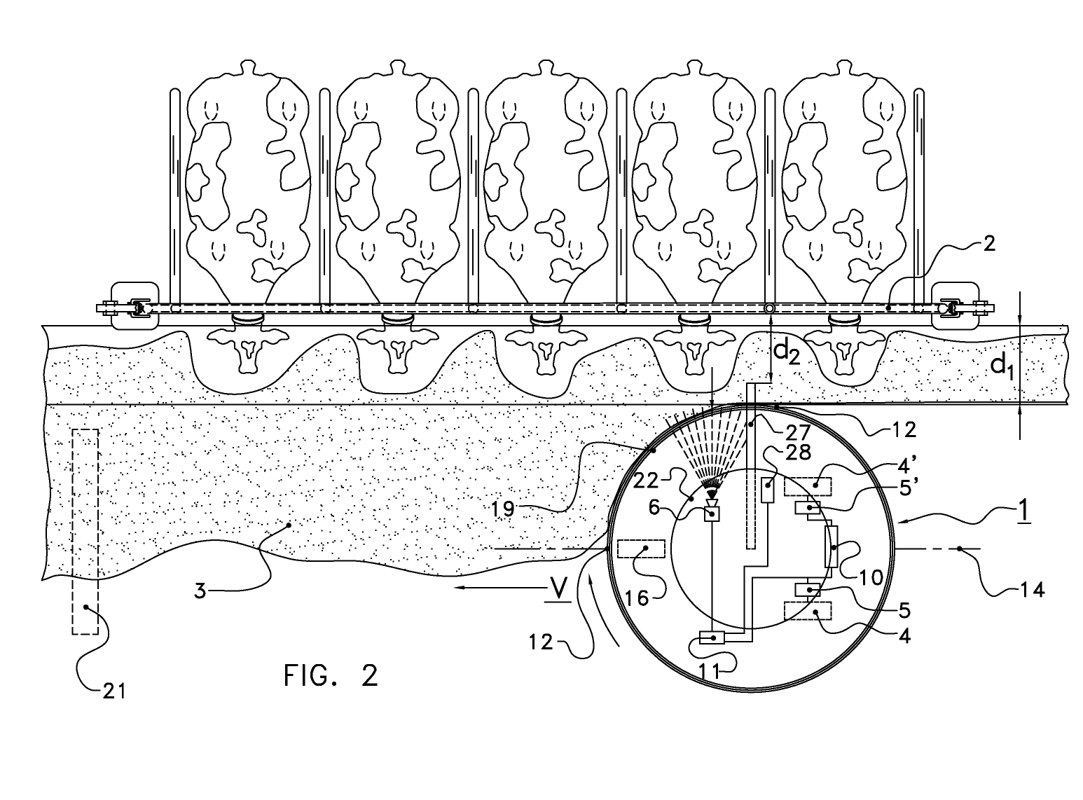

FIG. 1 shows a diagrammatic side view in cross section of an embodiment of an autonomous, unmanned vehicle 1 according to the invention. The vehicle 1 comprises wheels 4 (see FIGS. 2) and 4′, driven by drive mechanisms 5, 5′ (see FIG. 2), and an additional wheel 16.

The vehicle also comprises a distance sensor 6, a covering 7 with an opening 8, as well as a feed displacement means 12, charging strips 13, a safety bumper 15 and a height adjustment 18 for the wheel suspension 17. In this case, reference numeral 19 indicates a lowest point of feed displacement means 12. An inductive sensor 20 detects an induction strip 21.

Furthermore, the vehicle 1 comprises a feed supplement container 22 which contains feed supplement 24 and which has a metering opening 23. Reference numeral 25 denotes a dispensing device with a conveyor belt 26, a chute 27 which is movable in the direction of arrows A, and an adjustment means 28.

FIG. 2 shows a diagrammatic top view of an embodiment according to the invention. Here, similar parts are denoted by the same reference numerals. Reference numeral 2 denotes a feeding fence with feed 3 to be pushed. Furthermore, it shows a torque difference-determining means 10 and a control unit 11.

Reference is expressly made here to pages 7 to 12 of WO2009070007A1 which describes many details of the embodiments illustrated herein, and which is hereby incorporated by reference in its entirety. For this reason, a number of parts will at most be discussed only briefly in the following.

It should also be noted that the embodiment illustrated in FIG. 1 shows a dispensing device 25 which faces backwards with respect to a travel direction of the vehicle, but such orientation of the dispensing device has been depicted only for the sake of clarity. In use, the dispensing device 25 will functionally project to the side, that is, along a plane substantially perpendicular to a vertical plane along the direction of travel V of the vehicle.

The feed supplement container 22 contains feed supplement 24, for example concentrate or mineral chunks. The container can have any desired shape and can, as is the case here, be placed outside the covering 7, but can also be placed inside the covering 7. All this may, for example, depend on the size of the container 22. The container 22 has a metering opening 23, via which the feed supplement 24 can be dispensed to a dispensing device 25, here in the form of an escalator conveyor belt 26 which, in turn, dispenses the feed supplement 24 metered thereon to a chute 27, via which the feed supplement can eventually be dispensed.

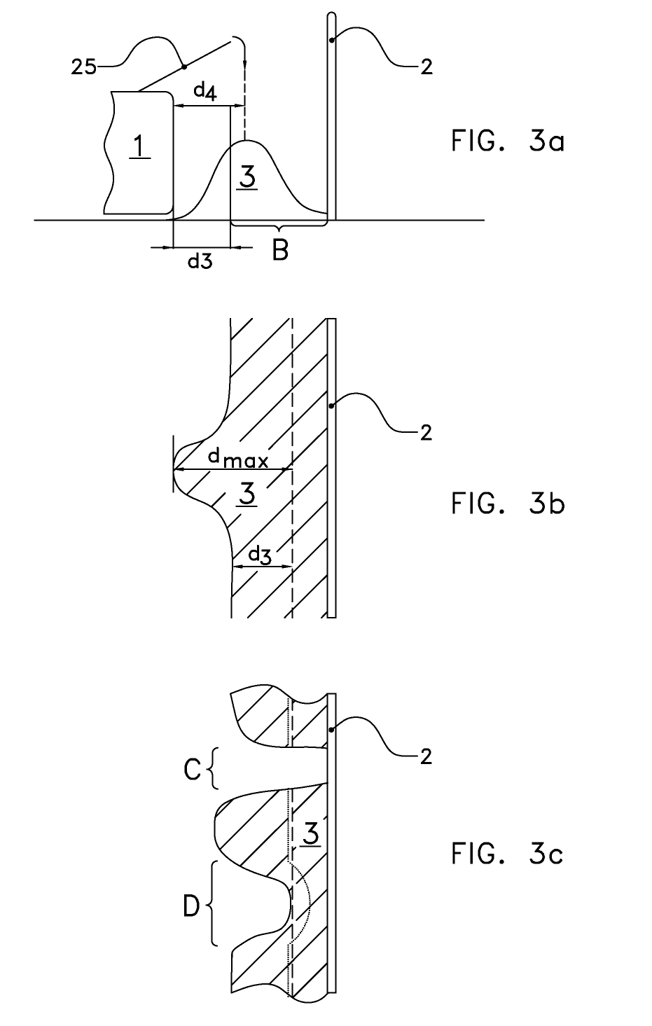

The chute 27 is adjustable by means of adjustment means 28. For example, this means sets an angle a, so that the chute 27 is moved in the direction of the arrows A. Thus, it is possible to set a different dispensing distance. See FIGS. 3a-c for dispensing distance setting examples. The adjustment means 28 in this case comprises, for example, a stepping motor or the like which is operatively connected to the control unit 11. Alternatively, the adjustment means 28 may also comprise an optionally telescopic extending device for the chute 27 or the overall dispensing device 25 by means of which the dispensing distance can be set very directly.

The control unit 11 is also operatively connected to the distance sensor 6 which, in the illustrated embodiment, determines a distance to the feeding fence 2. Distance sensor 6 is, for example, an ultrasound sensor or a 3D camera. On the basis of the measured distance, the control unit 11 controls the drive mechanism 5, 5′ of the wheels 4, 4′ in order to push the feed 3 in a direction towards the feeding fence 2 with the vehicle, in principle as far as a distance d1, as can be seen in FIG. 2. Furthermore, control unit 11 controls the dispensing device 25, in particular the adjustment means 28, in such a manner that the dispensing distance, denoted by d2 in FIG. 2, with respect to the feeding fence 2 is maintained.

However, there may be cases where there is so much feed 3 on the ground that the vehicle 1 encounters too much resistance when pushing it laterally, and the distance d1 therefore becomes greater than the distance to be maintained. In this case, the distance d2 will generally also become greater in a direction away from feeding fence 2, which is undesirable. In this case, the control unit 11 readjusts the adjustment means 28, so that at least the distance d2 does not change, obviously only to the extent that the mechanical limits of the overall vehicle allow this. It should be noted that the presence of excess feed 3 can also be determined by means of the torque difference-detecting means 10 which is operatively connected to the control unit, which will output an excessive feed signal if the vehicle 1 encounters too much resistance.

It is also possible that there is, on the contrary, too little feed 3 on the ground. FIG. 2 shows an example thereof near the heads of the illustrated animals, in this case cows. They have eaten the feed 3 beyond the distance d2. With the known devices, this could result in feed supplement 24 being dispensed on the ground. By now determining whether there is feed 3 in the area where feed supplement 24 is to be dispensed using the distance sensor 6, in this case an ultrasound sensor or 3D camera, it is possible to prevent waste. If the ultrasound image or 3D image shows that there is no feed 3, then no feed supplement has to be dispensed. Alternatively, the distance d2 may be changed such that the feed supplement 24 is dispensed in an area where feed 3 is indeed present. Another alternative is to change the pushing procedure in such a manner that pushing is carried out laterally until a certain resistance is encountered by the vehicle. In this way, it is also possible for the distance d1 to vary and for the dispensing distance d2, at least the dispensing device, to be adapted accordingly. It should be noted that all distances may also depend on the type of animal, since, for example, a cow is much larger than many other animals, and can perhaps reach further with its head.

FIGS. 3a-c diagrammatically show three scenarios which have in part already been indicated above.

FIG. 3a shows a diagrammatic sectional view of a case in which feed supplement is dispensed at a distance d4 which is greater than a distance d3 and is situated in an area B. This prevents dispensation of feed supplement in an area with a slope which is too steep, indicated in the figure by the portion which is at a maximum distance d3 to the vehicle. By contrast, the area “B” is the area which is either sufficiently flat or ensures that feed supplement can roll in the direction of the feeding fence 2. Although the distance d3 may obviously vary considerably, 25 to 30 cm may be given as a guideline, although this is obviously also dependent on the type of feed 3 and the pushing mode which has been set on the vehicle 1.

FIG. 3b shows a diagrammatic top view of a case in which too much feed 3 was situated on the ground locally to be able to push it, thus resulting in the “bump” protruding on the left. In this case, in order not to dispense the feed supplement 24 outside the reach of the animals, which reach is diagrammatically indicated by the dashed line, the dispensing distance, which is d3 elsewhere, will be increased to a maximum of dmax at that location. The required distance information can obviously be obtained by means of the distance sensor 6 shown in FIGS. 1 and 2.

FIG. 3c shows a section where there is less feed 3 in front of the feeding fence 2. There is a sudden discontinuity in the feed, with no feed present in area C. In that case, it makes no sense to dispense feed supplement 24, and the dispensing of feed, indicated by the dotted line, is ceased. Whether or not feed 3 is present can be detected, for example, by means of the ultrasound or 3D distance sensor 6 from FIG. 1 or 2. If the latter does not give off a signal against the background of the ground itself, it can be assumed that there is no feed.

There is also less feed 3 in area D, in such a manner that the normal dispensing distance, indicated by the dotted line and which in FIG. 3b coincides with the dashed line corresponding to the reach of the animals, is too close to the edge of the feed 3. In this case, the feed 3 may or may not have been pushed, and if it has been pushed a mound of feed having a steep slope may have formed.

In order to prevent the situation shown in FIG. 3a from occurring without correction with respect to a steep slope taking place, the dispensing distance is changed, at least with respect to the feeding fence 2. This is illustrated by the dotted line making a dent towards the feeding fence 2. Thus, a sufficiently large distance will remain between the dispensing position and the edge of the feed 3, such as for example 25 to 30 cm.

The above-described variation in the dispensing distance can also be used, for example, without the local absence of feed triggering this. By varying the dispensing distance, but staying within the reach of the animals, namely, up to the dashed line, the dispensation of feed supplement can be spread, offering advantages for the intake of both feed and feed supplement. To this end, the control unit 11 can be designed to further vary the dispensing distance of the dispensing device, in a manner independent from a local parameter. For example, the adjustment means 28 may carry out a periodical oscillating movement, such as sinusoidal or triangular or zigzag-shaped.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. An autonomous feed displacement vehicle moving on a surface, comprising a frame which is provided with
a drive mechanism,
a feed displacement device configured to push aside feed situated on the surface,
a container for a feed supplement to be dispensed, and
a dispensing device for dispensing the feed supplement from the container;
wherein the vehicle comprises an adjustment device configured to adjust the dispensing device in order to dispense the feed supplement at a desired, adjustable dispensing distance.

2. The autonomous feed displacement vehicle of claim 1, wherein the adjustment device is configured to autonomously adjust the dispensing distance of the dispensing device on the basis of at least one position-dependent parameter.

3. The autonomous feed displacement vehicle of claim 2, wherein the at least one position-dependent parameter is the distance from the vehicle to a guiding device and wherein the vehicle comprises a distance-determining device configured to determine the distance between the vehicle and the guiding device.

4. The autonomous feed displacement vehicle of claim 3, wherein the guiding device is a feeding fence.

5. The autonomous displacement vehicle of claim 1, wherein the adjustment device is configured to adjust the dispensing distance within a predetermined access range with respect to the guiding device.

6. The autonomous feed displacement vehicle of claim 2, wherein the vehicle further comprises a material-detecting device configured to detect material on the surface along a direction perpendicular to a direction of movement of the vehicle between the vehicle and the guiding device, and wherein a position-dependent parameter is the presence of detected material on the surface.

7. The autonomous feed displacement vehicle of claim 6, wherein the material to be detected by the material-detecting device comprises feed.

8. The autonomous feed displacement vehicle of claim 6, wherein the adjustment device is configured to adjust the dispensing distance within a range in which material has been detected on the surface

9. The autonomous feed displacement vehicle of claim 1, wherein the dispensing device comprises a chute, auger or conveyor belt or any combination thereof.

10. The autonomous feed displacement vehicle of claim 9, wherein the adjustment device further comprises an angle adjustment and/or length adjustment device configured to adjust an angle and/or a length of the chute, auger, conveyor belt or combination thereof.

11. The autonomous feed displacement device of claim 1, wherein the adjustment device is a dispensing rate adjustment device.

12. The autonomous feed displacement device of claim 1, wherein the dispensing device is configured to vary the dispensing distance.

13. The autonomous feed displacement device of claim 12, wherein the dispensing device is configured to vary the dispensing distance according to a pattern or according to a regular pattern.
